(19) United States
(12) Patent Application Publication
(10) Pub. No.: US 2015/0079287 A1
(43) Pub. Date: Mar. 19, 2015

(54) Method for Applying a Shaped Coating to a Surface

(71) Applicant: Garry Cyrille Alfred VanDenBerghe, Coldstream (CA)

(72) Inventor: Garry Cyrille Alfred VanDenBerghe, Coldstream (CA)

(21) Appl. No.: 14/029,051

(22) Filed: Sep. 17, 2013

(51) Int. Cl. B05D 1/32

(52) U.S. Cl. CPC B05D 1/32
USPC 427/282

(57) ABSTRACT

A shaped colored coating such as a logo or graphics is applied to a surface by adhesively attaching a tape to the surface at a demarked edge of the shape and applying an adhesive masking sheet over the tape body. The masking sheet is torn at the edge by pulling a filament of the tape through the masking sheet. A removable portion of the masking sheet and the tape are removed and the edge of a masking portion adhesively attached to the surface at the demarked edge. After application of the coating, the masking portion is removed to leave the coating on the surface up to the demarked edge and to carry away the part of the coating on the masking portion.

This invention relates to a method for applying a shaped coating such as a paint layer to a surface, where the finished coating has a pattern or shape over the surface leaving other parts of the surface outside the shape which are not coated.

### BACKGROUND OF THE INVENTION

The application of a paint or other covering layer to a surface is very wide spread and used in many industries. One particular example is the airline industry where the aircraft body is typically painted with the logo and other information relating to the airline company. The present invention thus can be used in many different industries where a shaped pattern in a colored coating such as paint is required to be applied to a surface of an object and where colored film cannot be used to apply the coating defining the shape.

The application of paint into a shaped pattern is typically carried out using a masking material which is applied to the surface up to a demarked edge of the shape to be coated. This is typically done by hand by cutting up the materials such as paper into the required shape and applying the material onto the surface using adhesive such as adhesive masking tape. This is time consuming and relatively crude so that the finished product may have poorly defined edges at the demarked edge of the shape.

Film type masking material has also come into recent use where a large cutting machine using computer plotting is used to cut a wide sheet of an adhesive film into a required configuration with removable sections so that the shape is defined by cut lines in the sheet and the sheet can be applied to the surface as a complete covering and the removable sections taken away to expose the shape for the paint covering. This requires the availability of the cutting machine and sufficient pre-planning for the machine to be programmed with the required configuration. Also the size of the shape is limited to the width of the sheet available. In many industries it is completely unacceptable to cut the film with a cutting blade while already applied to the surface since marring of the surface cannot be tolerated.

### SUMMARY OF THE INVENTION

It is one object of the invention to provide method for applying a shaped coating to a surface.

According to a first aspect of the invention there is provided a method of applying a shaped coating to a surface comprising:

defining on the surface a shape defined by a demarked edge of the shape for the coating to be applied on to the surface;

adhesively attaching a tape to the surface at the demarked edge, the tape comprising:

a tape body having a front surface, a rear surface, a first longitudinal side edge and a second longitudinal side edge;

the tape body having an adhesive on the rear surface for attachment to the surface;

the tape body having at least one longitudinally extending filament attached thereto;

providing a masking sheet for the surface separate from the tape body and applying the masking sheet over the tape body at the demarked edge;

pulling the filament so that the filament tears through the masking sheet to divide the masking sheet at the demarked edge into a removable portion which extends over the shape and a masking portion which extends over the surface for masking the surface, with an edge of the masking portion at the demarked edge;

removing from the surface the removable portion of the masking sheet;

removing from the surface the tape body;

the edge of the masking portion being adhesively attached to the surface at the demarked edge;

applying the coating to the shape on the surface so that a part of the coating extends from the shape over the demarked edge onto the masking portion of the masking sheet;

and removing the masking portion to leave the coating on the surface up to the demarked edge;

the removing of the masking portion acting from the surface to separate the coating at the demarked edge leaving an edge of the coating at the demarked edge and to carry the part of the coating on the masking portion.

In some cases the masking portion forms a relatively wide sheet so that it has a width at the demarked edge which is sufficient so that any of the coating applied to the surface beyond the demarked edge falls onto the masking portion.

In other cases there is provided a separate masking material such as paper which is applied to the surface to form an edge of the masking material adjacent to and spaced from the demarked edge and the adhesive masking sheet or film comprises a relatively narrow band for example 4 to 6 inches sufficient only to cover the tape and extend to the edge of the masking material.

Preferably the tape is extensible so as to allow bending to at least one side by extension along the opposite side.

Preferably the filament is spaced from both side edges to allow bending in both directions. However the filament can be arranged along one edge which would preferably be the edge at the demarked edge of the shape so that the remainder of the tape lies under the removable portion to be removed therewith.

Preferably the filament is less extendible than the tape.

Preferably the filament is carried in or on the adhesive on the rear surface.

In a particularly preferred arrangement which has been found to provide the best cutting effect, the filament is spaced from the first and second side edges and the tape body has a width arranged such that the filament tears through at least a part of the thickness of the tape body along the length of the tape body, when pulled to cut the masking sheet, rather than pulling from one side edge of the tape body. In this way the tearing of the tape body leaves a portion of the tape body underneath the edge of the masking portion which has to be removed and the edge of the masking portion re-laid onto the surface.

Preferably the masking sheet carries an adhesive and the front surface of the tape body has release characteristics relative to the adhesive on the masking sheet to allow release of the masking sheet from the tape body. In this case the release characteristic of the tape can be provided by the characteristics of the substrate itself and not by an applied release coating. However release coatings can also be used.

The masking sheet should be selected so that it can be readily slit using the filament. Typically this requires a polymer film where a cut line readily propagates along the sheet. Typically paper and similar material are not suitable since the cut line formed by tearing a filament through the sheet forms jagged edges. However it will be appreciated that various sheets can be used depending on the accuracy and cleanliness of the cut line required in that particular industry or object to be coated.

Preferably the coating comprises a colored paint layer. However other coatings can be applied using the method described, provided the coatings are of a nature which separates by pulling the masking portion away from the surface without any need for additional cutting of the coating. That is the coating to be applied is not a film. That is the coating is not a thick wear coating, such as polyurethane, which must be actively cut at the edge since its thickness and strength prevent it from being torn simply by the removal of the masking portion. Typically the coating is for application of shaped colored layers but it is envisaged that the coating applied may be for other purposes than just coloring. The coatings may be of complex shape and overlying to provide various coloring effects such as graphics on a road vehicle.

In some industries such as the automobile industry, the edge of the coating must be very carefully and accurately prepared with no jags or blurs since the observers are located directly at the surface and can see any such faults. For these industries the cut line through the masking sheet must be very accurate and very fine so that the filament described in more detail in the paragraphs below would be highly desirable even through the strength of the filament may be reduced. In other industries where the observation of the demarcation lines is relatively remote, such as the aircraft industry where aircraft cannot be closely approached, the accuracy of the cut line through the masking sheet may be of less importance allowing use of a thicker and stronger filament.

For fine cutting of the masking film, the filament preferably has one or more of the following characteristics:
the filament is extendible so that, when the tape is stretched during pulling from a supply roll and when applied to the surface, the filament stretches with the tape;
the filament has a strength so that, when applied to the surface, an end of the tape and filament can be broken by hand pulling of the tape without the necessity for cutting;
the filament has a strength so that, when pulled from the tape for cutting the film, the filament cuts the film without breaking;
the filament has an ability to bend to a radius of curvature of less than 0.5 inches without any stiffness in the filament;
the filament has a weight per unit length which equates to a calculated diameter of the filament, based on an assumption that the filament is circular in cross-section, of less than 0.005 inch.

The filament may be a monofilament, a twisted multi-filament cord or may be a multi-fiber composite filament for example a twisted multi-fiber filament.

The filament is preferably a polymeric material such as polyester or nylon.

It will be appreciated that such polymeric materials when formed into filaments are typically not circular in cross section so that their cross-section is measured in a weight per unit length measurement of tex which is the mass of the filament in grams per 1000 meters of the filament or denier which is the mass in grams of 9000 meters of the filament.

One can calculate the diameter of a filament (assuming it is circular in cross-section, which is typically not correct) given its weight in denier with the following formula:

$$Ø = \sqrt{\frac{4.444 \times {10}^{- 6} \cdot denie r}{π ρ}}$$

where ρ represents the material's density in grams per cubic centimeter and the diameter is in cm.

Or using the following formula based on dTEX (grams per 10,000 meters length)

$$Ø = \sqrt{\frac{4 \times {10}^{- 6} \cdot dtex}{π ρ}}$$

where ρ represents the material's density in grams per cubic centimeter and the diameter is in cm.

The intention in the present filament is that it has a diameter (assuming it is circular) of less than 0.005 inch (0.127 mm) and preferably less than 0.003 inch (0.0762 mm) and preferably less than 0.002 inch (0.0508 mm) and preferably less than 0.001 inch (0.0254 mm). Depending on the material from which it is formed, the tex or denier of the material can be calculated using the density of the material concerned.

The filament is selected from one of these materials such that it has the minimum diameter to meet the strength requirements for the cutting action set forth above.

Such characteristics of the filament cannot be met by filaments of metal (typically steel), Kevlar or UHMW polyethylene which have a high elastic modulus and cannot be elongated along their length. These materials have very high strength and are typically selected for this purpose on the ground that high strength is required. The present inventors have realized that strength is of secondary importance provided there is sufficient strength to actually cut through the film, and the tape if the filament cuts the tape simultaneously. Thus the strength should be the minimum which can be acceptable and instead the diameter of the filament should be minimized while providing the required strength.

Thus the strength of the filament must be greater than 1.0 pound force to break, so that the action of cutting can be carried out. Where the strength is only slightly greater than 1.0 pounds force it can be maintained less than 3.0 pounds which allows the tape and filament to be both broken by hand.

Thus the filament itself has a strength to break in the range 1 to 3 pounds force. That is a filament having a strength to break greater than 3 pounds and up to 5 pounds is less desirable to use because the strength is unnecessary so that the filament is better to be finer than stronger. It has been established that t pull strength of the order of 1 pound is sufficient to allow the filament to tear through multiple layers simultaneously of the vinyl material provided by 3M which is the preferred film used in the industry. Provided this can be achieved, any additional strength is unnecessary.

Thus the combination of the tape and the filament has a strength to break of less than 3.5 pounds force which reasonable allows the tape and filament to be snapped by hand by the installer as he reaches the end of the tape strip to be applied. This is of significant advantage in the time required for installation. This ability to hand break the tape and filament is a consequence of the realization that the high strength required in previous proposals is not required.

With regard to extensibility, the tape itself is highly extensible having an extension under a load of 8 to 12 pounds force per inch width of the order of 300 to 830%. In many cases the tape is formed of polyethylene or a polyethylene/polyester multi polymer film mix, which provides the high extensibility. Such a high extension under load allows the tape to bend left to right in its plane to follow curvatures of less than 0.5 inches as set forth above. To achieve such curvatures in a tape of the order of 0.125 inches in width and wider, one side must extend significantly relative to the other side creating an extension gradient across the tape. Previous filaments in order to achieve the high strength believed to be required have been basically inextensible under the loads involved.

The filament for fine cutting has been determined to require an extension greater than 15% under a load of 1.0 pounds force. This extension of the filament allows it to extend during the side to side bending of the tape. This extension of the filament allows it to extend during the application of the tape to the surface. That is the filament extends with the tape as the tape is pulled by the installer with a significantly reduced tendency of the filament to break out of the tape. It has been found that inextensible filaments of the type previously used and proposed, due to the differential in extension from the tape, tend to break out of the adhesive leaving the filament and tape as separate components so that the installer must try to apply the tape while re-inserting the filament into the tape as it is applied. This pulling action on the tape can occur as it is pulled off the supply roll or as it is applied onto the surface. In both cases the separation of filament and tape is highly problematic.

The above stated extension of 15% under a load of 1.0 pounds force has been found to be sufficient to allow the tape and filament to remain connected during the level of stretching of the tape which occurs in practice. The reduction in differential forces tending to separate the filament from the tape also reduces the requirement to have a high bond between the filament and the adhesive on the tape so that filaments which are inherently less able to bond to the adhesive can be used.

Thus the tape with the filament attached should turn through a radius of curvature in both directions (in the plane of the tape) which is less than 3 inches and more preferably less than 1.0 m inch or even 0.5 inch without the filament pulling away from the underneath the tape. That is the adhesion of the filament underneath the tape and the ability of the tape and filament to generate the differential stretch must be necessary to make these turns.

The above reduction in required strength which leads to a reduction in diameter (or denier) of the filament also allows a further significant advantage in that the necessity to bond the filament to the adhesive on the tape or bond the adhesive to the surface is much reduced. A high diameter of the filament of greater than 0.005 inch lifts the tape at the location of the filament away from the surface in a “tenting” effect which necessarily reduces the contact width of the adhesive on the surface. A filament of smaller diameter allow a greater width of the tape to be applied to the surface thus increasing the bond of the tape to the surface and reducing the possibility that the filament can escape from the highly bonded tape.

Thus a filament useable in the above method preferably has the following characteristics:

A strength to break in the range 1 to 3 pounds force;

An extension of at least 15% under a load of 1.0 pounds force

A weight per unit length which equates to a calculated diameter of the filament, based on an assumption that the filament is circular in cross-section, of less than 0.005 inch;

the ability to bend, with zero resistance to bending, to a radius of curvature of less than 0.5 inches.

In one example, a polyester multifiber filament of 16 tex can be used which provides a strength to break of 2 pounds force, an extension of 15% under a load of 1.0 pounds force.

The 16 tex polyester fiber described herein has a calculated diameter a little less than 0.005 inch.

This filament with a tape formed from polyethylene of 0.125 inch in width has a combined breaking strength of 2.5 pounds force and can bend side to side to a radius of curvature of 0.5 inches without the filament breaking out from the tape.

This filament provides a breaking strength sufficient to cut through 3 layers at a total of 18 mil thickness of materials from 3M sold under the designation 480cv3 which has been recently introduced. The filament can also cut four layers at a total of 20 mil thickness of conventional vinyl film and provides a cut line which under magnifying glass is a clean line with no jagged edges. It will be appreciated in this regard that the filament is in some cases required to cut through more than one layer of film and up to three or four layers where the films are overlaid to provide a particular graphics effect with the films.

Preferably the tape is extensible so as to allow bending to at least one side by extension along the opposite side.

Preferably the filament is spaced from both side edges to allow bending in both directions. However the filament can be located at or adjacent one edge and other techniques used to effect bending away from the edge with the filament.

Preferably the tape body consists of a single layer.

Preferably the tape body carries only the filament.

Preferably the filament is located substantially at a center line of the tape body.

In most cases the tape is free from adhesive on the front surface. However the tape can be arranged for the front surface to stick to the masking sheet covering the tape.

Typically the adhesive of the tape has the characteristic that the tape body can be pulled from a surface of the object without leaving an adhesive residue and without damaging the surface.

Preferably the filament is carried in or on the adhesive on the rear surface. In this case, the adhesive is arranged to hold the filament in place on the tape during bending of the tape while the tape is applied to the surface and while the filament is being pulled to effect the cutting of the film. In this case, the filament when carried on the adhesive has a coating material compatible with the adhesive for generating an improved adhesion between the filament and the adhesive.

In an alternative arrangement, the adhesive is applied onto the substrate over the filament to hold the filament against the surface of the substrate.

Preferably the masking sheet is adhesive for attachment to the surface and over the front surface of the tape.

Preferably the tape is formed of a plastics material allowing stretch of the tape greater than that of the filament. Preferably the tape is formed of a PVC. Preferably the pressure sensitive adhesive on the tape is rubber based as this can provide the required properties of adhesion and subsequent removal of the tape.

In accordance with another feature the tape may comprise a laminate of a first substrate carrying the adhesive on a rear surface thereof and a second substrate carrying a release layer on a front surface thereof with the filament located between the first and second substrates.

The tape may include a substrate with the adhesive applied to one surface of the substrate, or the tape may comprise simply an adhesive material with the filament attached thereto or embedded therein.

The filament can be formed of any suitable material which has sufficient strength to carry out the cutting action when pulled without breaking and a sufficient cutting action to effect cutting and not tearing the coating. Metal wire is typically suitable. Other materials such as carbon fiber or Kevlar fiber can be used. MOPP (mono-axially oriented polypropylene) is preferred.

The tape body can be formed of a paper product which can stretch such as crepe paper or from a plastics material such as polyethylene. A stretch of up to 300% is desirable to provide suitable curvatures. No cutting of the edges of the tape is required to form any required curvature.

### BRIEF DESCRIPTION OF THE DRAWINGS

One embodiment of the invention will now be described in conjunction with the accompanying drawings in which:

FIGS. 1 to 7 show cross sectional views through a series of method steps using a first embodiment of tape of the present invention.

FIG. 8 shows a front elevational view of the shape on the surface with the tape applied.

FIG. 9 shows an alternative embodiment where the masking sheet forms a narrow band where the band coves an edge of a masking material such as paper.

FIGS. 10 to 12 show cross sectional views through a series of method steps using a second embodiment of tape of the present invention.

In the drawings like characters of reference indicate corresponding parts in the different figures.

### DETAILED DESCRIPTION

Reference is made to U.S. Pat. Nos. 8,187,407 and 8,361,615 of the present applicant corresponding to Canadian patent 2700471 which show a similar arrangement of tape for use in applying a film, the disclosure of which is incorporated herein by reference.

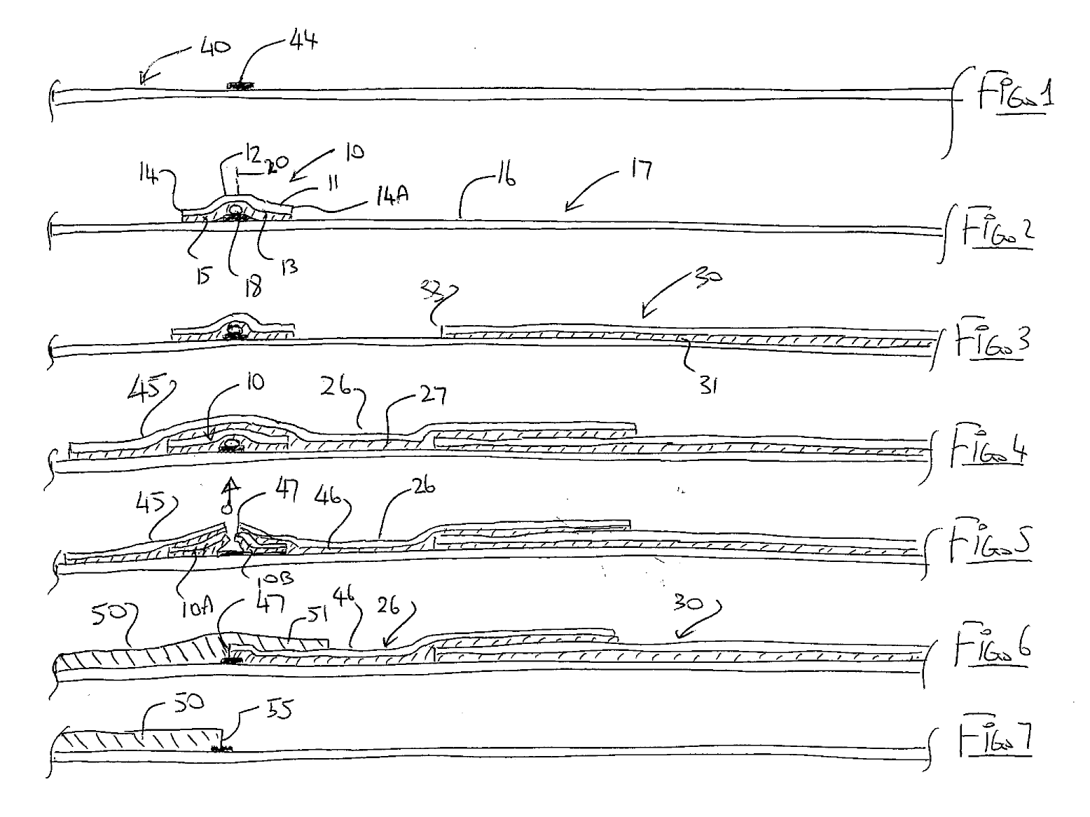

In FIGS. 1 to 7 is shown a tape 10 for use in a method according to the present invention which includes a tape body or substrate 11 having a front surface 12, a rear surface 13, a first longitudinal side edge 14 and a second longitudinal side edge 14A. The tape body 11 has an adhesive 15 covering the rear surface 13 for attachment of the tape body to the surface 16 of an object 17 to be coated. The tape body 11 has a longitudinally extending filament 18 attached thereto. In this embodiment, the filament is applied onto or into the layer 15 so as to be held on the surface 13.

The filament 18 is attached to the tape body 11 at a position thereon spaced from both side edges of the tape, that is at or adjacent a center line 20. The width of the tape and the spacing of the filaments to a distance from the side edge allows bending of the tape in a first side to side direction by extension of the tape along the second longitudinal side edge and in a second side to side direction by extension of the tape along the first longitudinal side edge.

On top of the front surface 12 of the tape body 11 is a release characteristic which allows the tape to be rolled into a supply length without interference between top surface and the adhesive 15.

A masking sheet 26 is provided for application over the tape 10 and onto the surface 16 on both sides of the tape 10. The masking sheet 26 can be self-adhesive by an adhesive layer 27 so as to attach to the surface 16 and the exposed surface 12 of the tape body 11. A separate masking material 30 is also supplied with an adhesive layer 31

The steps in the process are shown in FIGS. 1 to 7.

As shown in FIG. 1, a shape defined 40, 41, 42 is on the surface by a demarked edge of the shape 44 for the coating to be applied on to the surface.

As shown in FIG. 2, the tape 10 is adhesively attached to the surface 16 at the demarked edge 44 with the filament 18 directly overlying the edge 44.

As shown in FIG. 3, there is provided a masking material 30 for the surface 16 separate from the sheet 26 and from the tape body 10 which is applied on to the surface 16 to an edge 33 adjacent to but spaced from the demarked edge 44 by a distance of the order of a couple of inches so that the material 30 can be quickly and easily applied with little care and attention to the specific position of the edge 33.

As shown in FIG. 4, there is provided the masking sheet 26 for the surface 16 separate from the tape body 10 which is applied over the tape body at the demarked edge 44 and over the edge 33 onto the upper surface of the material 30.

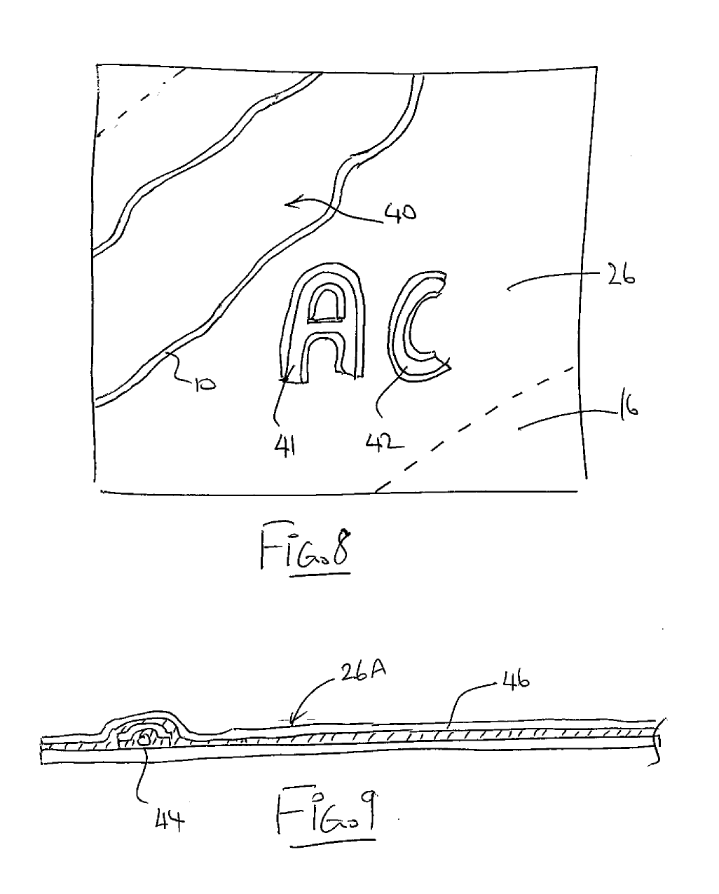

As shown in FIG. 5, the filament 18 is pulled so that the filament 18 tears through the masking sheet 26 to divide the masking sheet at the demarked edge 44 into a removable portion 45 which extends over the shape 40 and a masking portion 46 which extends over the surface 16 for masking the surface, with an edge 47 of the masking portion 46 located at the demarked edge

As shown in FIG. 6, the removable portion 45 of the masking sheet is removed from the surface exposing the shape at the surface. Also the tape body is removed. In FIG. 6 the pulling of the filament acts to tear the tape body into two portions 10A and 10B and both are removed so that the portion 10A can be removed with the portion 45 and the portion 10B can be carefully pulled out from underneath the edge of the portion 46 and pulled away. The edge 47 of the masking portion is then adhesively re-attached to the surface 16 at the demarked edge 44.

With the masking sheet properly applied exposing the shape 40 and providing a clean effective edge of the portion 46 at the edge 44, the coating 50 is applied using any conventional technique to the shape on the surface. Such techniques such as brush application or more preferably spray coating acts so that a part 51 of the coating 50 extends from the shape over the demarked edge 44 onto the masking portion 46 of the masking sheet.

As shown in FIG. 7, the masking portion is removed to leave the coating 50 on the surface up to the demarked edge 44 where the removing of the masking portion acting to separate the coating from the surface at the demarked edge leaving an edge 55 of the coating 50 at the demarked edge 44 and to carry the part 51 of the coating on the masking portion. Thus the present arrangement is intended to be used with coatings such as paint which easily can be torn and separated at the edge 44 by merely pulling the masking sheet away. The arrangement is not intended to be used with hard coatings which need to be cut.

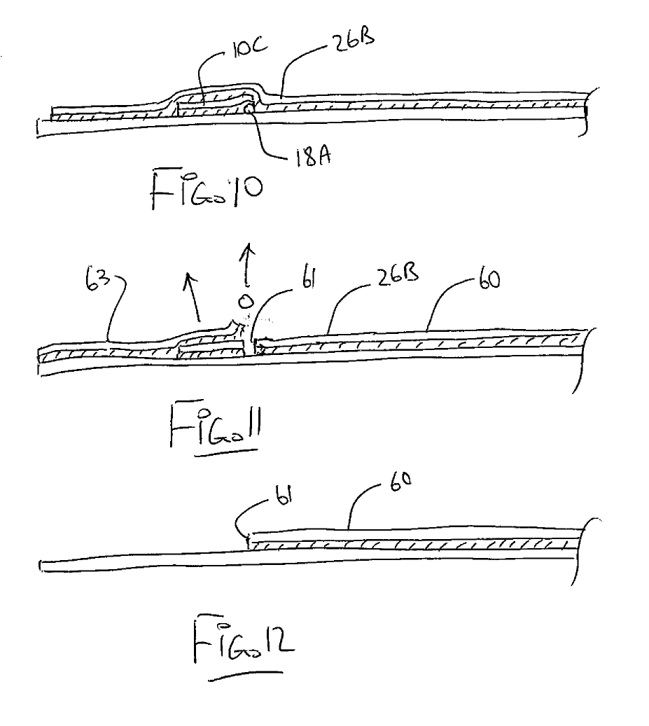

In FIG. 9 is shown an arrangement in which the masking sheet 26A is relatively wide so that the masking portion has a width at the demarked edge 44 which is sufficient so that any of the coating 50 applied to the surface beyond the demarked edge 44 falls onto the masking portion 46.

FIGS. 1 to 6 show the embodiment where a masking material 30 is provided which is applied to the surface to form an edge of the masking material adjacent to and spaced from the demarked edge and the masking sheet comprises a band of a width to cover the tape and the edge of the masking material.

As shown in FIG. 2, the filament is carried in or on the adhesive 15 on the rear surface 13.

The tape 10 is extensible so as to allow bending to at least one side by extension along the opposite side and as shown the filament 18 is spaced from both side edges 14, 14A to allow bending in both directions with the filament being less extendible than the tape.

That is the filament 18 is spaced from the first and second side edges 14, 14A and the tape body 10 has a width arranged such that the filament 18 tears through the tape body along the length of the tape body, when pulled to cut the masking sheet, rather than pulling from one side edge of the tape body so that the tearing of the tape body leaves a portion of the tape body underneath the edge of the masking portion. In this arrangement the portion of the tape body underneath the edge of the masking portion is removed after the masking sheet is cut and the edge of the masking portion is laid flat on the surface for adhesive attachment thereto.

As shown in the embodiment of FIGS. 10 to 12, the filament 18A is attached at or adjacent one edge of the tape body 10C. In this way as shown in FIG. 11, as the filament is pulled it pulls out from the side edge 14A and tears through the masking sheet 26B to form an edge 61 of the masking portion 60. In this embodiment there is no portion of the tape left under the masking portion 60 for separate removal. As the whole of the tape body 10 is removed with the removable portion 63, there can be an adhesive connection between the tape body and the masking sheet thus removing the need for release characteristic.

1. A method of applying a shaped coating to a surface comprising:
defining on the surface a shape defined by a demarked edge of the shape for the coating to be applied on to the surface;
adhesively attaching a tape to the surface at the demarked edge, the tape comprising:
a tape body having a front surface, a rear surface, a first longitudinal side edge and a second longitudinal side edge;
the tape body having an adhesive on the rear surface for attachment to the surface;
the tape body having at least one longitudinally extending filament attached thereto;
providing a masking sheet for the surface separate from the tape body and applying the masking sheet over the tape body at the demarked edge;
pulling the filament so that the filament tears through the masking sheet to divide the masking sheet at the demarked edge into a removable portion which extends over the shape and a masking portion which extends over the surface for masking the surface, with an edge of the masking portion at the demarked edge;
removing from the surface the removable portion of the masking sheet;
removing the tape body;
the edge of the masking portion being adhesively attached to the surface at the demarked edge;
applying the coating to the shape on the surface so that a part of the coating extends from the shape over the demarked edge onto the masking portion of the masking sheet;
and removing the masking portion to leave the coating on the surface up to the demarked edge;
the removing of the masking portion acting to separate the coating from the surface at the demarked edge leaving an edge of the coating at the demarked edge and to carry the part of the coating on the masking portion.

2. The method according to claim 1 wherein the masking portion has a width at the demarked edge which is sufficient so that any of the coating applied to the surface beyond the demarked edge falls onto the masking portion.

3. The method according to claim 1 wherein there is provided a masking material which is applied to the surface to form an edge of the masking material adjacent to and spaced from the demarked edge and wherein the masking sheet comprises a band of a width to cover the tape and the edge of the masking material.

4. The method according to claim 1 wherein the tape is extensible so as to allow bending to at least one side by extension along the opposite side.

5. The method according to claim 1 wherein the filament is spaced from both side edges to allow bending in both directions.

6. The method according to claim 1 wherein the filament is less extendible than the tape.

7. The method according to claim 1 wherein the filament is carried in or on the adhesive on the rear surface.

8. The method according to claim 1 wherein the filament is spaced from the first and second side edges and the tape body has a width arranged such that the filament tears through at least a part of the thickness of the tape body along the length of the tape body, when pulled to cut the masking sheet, rather than pulling from one side edge of the tape body so that the tearing of the tape body leaves a portion of the tape body underneath the edge of the masking portion.

9. The method according to claim 1 wherein the portion of the tape body underneath the edge of the masking portion is removed after the masking sheet is cut and the edge of the masking portion is laid flat on the surface for adhesive attachment thereto.

10. The method according to claim 1 wherein the masking sheet carries an adhesive and the front surface of the tape body has release characteristics relative to the adhesive on the masking sheet to allow release of the masking sheet from the tape body.

11. The method according to claim 10 wherein the release characteristic of the tape are provided by the characteristics of the substrate itself and not by an applied release coating.

12. The method according to claim 1 wherein the filament is attached at or adjacent one edge of the tape body.

13. The method according to claim 1 wherein the coating comprises a colored paint layer.
